(19) United States
(12) Patent Application Publication
(10) Pub. No.: US 2025/0361448 A1
(43) Pub. Date: Nov. 27, 2025

(54) PROCESS AND APPARATUS FOR CONTINUOUS THERMAL DECOMPOSITION OF PLASTIC WASTE

(71) Applicants: Gregg Randow, Weston, WI (US); George Rattanasack, Weston, WI (US)

(72) Inventors: Gregg Randow, Weston, WI (US); George Rattanasack, Weston, WI (US)

(21) Appl. No.: 18/873,225

(22) PCT Filed: Jun. 9, 2023
(86) PCT No.: PCT/US2023/024910

§ 371 Date: Dec. 9, 2024

Related U.S. Application Data
(60) Provisional application No. 63/351,042, filed on Jun. 10, 2022.

(51) Int. Cl. C10G 1/02

(52) U.S. Cl. CPC C10G 1/02; C10G 2300/1003

(57) ABSTRACT

A process and device for continuous thermal decomposition of plastic waste. The process includes feeding the plastic waste continuously into an extruder to melt and extrude the plastic: feeding the melted plastic waste from the extruder continuously into a pyrolysis reactor: and condensing at least a portion of hydrocarbon vapors formed in the extruder and/or the pyrolysis reactor to yield liquid hydrocarbon fuel.

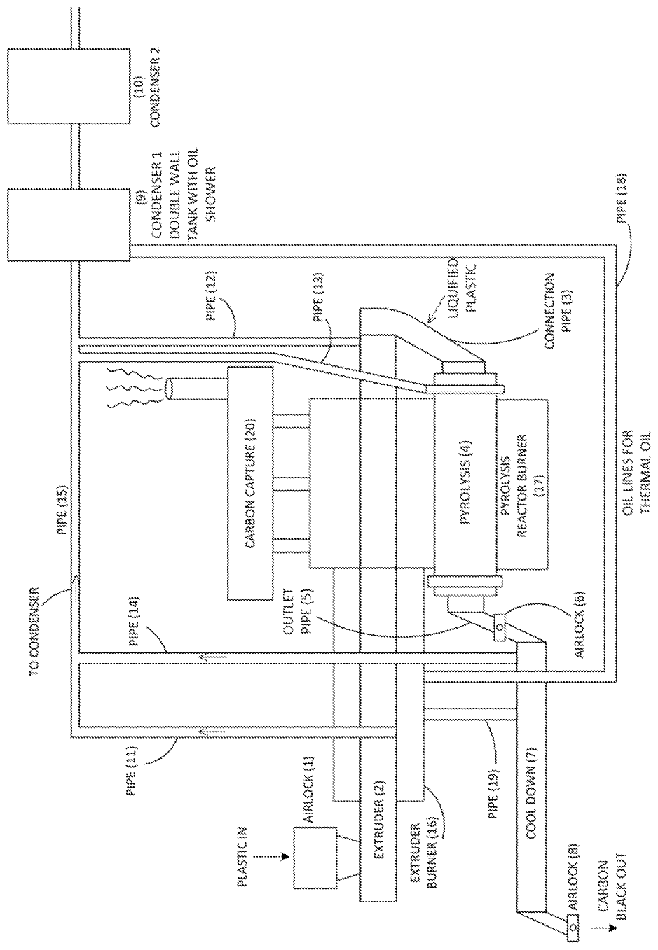

### CROSS-REFERENCE TO RELATED APPLICATIONS

Priority is hereby claimed to U.S. provisional application Ser. No. 63/351,042, filed Jul. 10, 2022, which is incorporated herein by reference.

### BACKGROUND

Plastic pollution has become one of the most imminent, worldwide environmental problems. The annual amount of plastic waste generated from municipal and industrial sources is continuously increasing and shows no signs of abating. A large portion of plastic waste generated each year is from single-use plastics. Currently, the overwhelming majority of single-use plastic waste is disposed via landfilling or incineration. Landfilling suffers from the limitation of land availability and leaching over time. Incineration (for the energy content of the burned plastics) yields secondary pollution in the form of the combustion products. Only a small portion of waste plastics are currently recycled in any form. Thus, there is a steadily increasing demand for technologies capable of converting plastic waste efficiently into useful products.

Pyrolysis is a process that has been investigated to convert plastic wastes into liquid fuel based. In pyrolysis, the largely hydrocarbon-based plastic waste is decomposed in an anaerobic environment by the application of heat. Pyrolysis can convert various waste plastics to liquid fuel. Theoretically, such an end result would effectively manage waste plastic and also yield economic benefits. However, pyrolysis requires high temperatures. Thus, overall energy consumption, environmental sustainability, and economic viability are prime concerns regarding using pyrolysis to convert waste plastic feedstocks into value-added products. Current plastic waste pyrolysis technologies suffer from low conversion efficiency, high energy consumption, and potential air pollution caused by gas emissions. Thus, there remains a long-felt and unmet need for a pyrolysis technology capable of achieving high-volume processing, at economically attractive costs, and reduced environmental impact.

### SUMMARY

Disclosed herein is a process for continuous thermal decomposition of a plastic waste stream. The process comprises:
feeding the plastic waste continuously into an extruder, wherein the plastic waste is melted at a temperature of from about 100° C. to about 350° C. and in some versions from about 140° C. to about 350° C.;
feeding the melted plastic waste from the extruder continuously into a pyrolysis reactor operating at a temperature of from about 280° C. to about 900° C. and in some versions from about 370° C. to about 450° C.;
condensing hydrocarbon vapors formed in the extruder and the pyrolysis reactor in a condensing system to yield liquid hydrocarbon fuel; and
discharging ashes (principally comprising carbon) formed in the pyrolysis reactor continuously.

In preferred versions of the process, the process uses a stacked horizontal parallel configuration with the extruder positioned above the pyrolysis reactor. The melted plastic from the extruder enters the pyrolysis reactor via gravity through a connection pipe. This minimizes the energy required to move the melt stream from the extruder to the pyrolysis chamber. To maintain pressure within the system, seals are used at the inlet of the extruder and at the outlet of the pyrolysis reactor where the carbon ashes are discharged. The working areas of the extruder and the pyrolysis reactor are within the inlet and outlet seals. Note that this configuration, with the extruder positioned above the pyrolysis pyrolysis reactor, is just one, non-limiting version of the device. The extruder can be positioned at any point relative to the reactor such that the outlet feed from the extruder can be fed into the pyrolysis reactor.

Also disclosed herein is a device dimensioned and configured for continuous thermal decomposition of plastic waste. The device comprises an extruder having an inlet and an outlet and configured to melt and extrude plastic waste at a temperature of about 100° C. to about 350° C. The outlet of the extruder is operationally connected to a pyrolysis reactor having an inlet and outlet and configured to operate at a temperature of about 280° C. to about 900° C. The extruder and pyrolysis reactor a configured and disposed such that plastic extruded from the outlet of the extruder enters the pyrolysis reacted via the pyrolysis reactor inlet. The device further comprises a condenser operationally connected to the extruder and/or the pyrolysis reactor. The condenser is dimensioned and configured to condense at least a portion of hydrocarbon vapors formed in the extruder and/or the pyrolysis reactor to yield liquid hydrocarbon fuel.

The device may optionally further comprise a burner disposed, dimensioned, and configured to heat the pyrolysis reactor to temperatures ranging from about 280° C. to about 900° C. The burner may optionally be connected to a carbon capture chamber dimensioned and configured to reduce carbon emissions from the burner. For example (and non-limiting), the carbon capture chamber may contain basalt which will absorb CO₂ generated by the burner.

In one version of the device, the condenser comprises a rain shower that contacts liquid hydrocarbon fuel with at least a portion of hydrocarbon vapors in the pyrolysis chamber, wherein the liquid hydrocarbon fuel is at a lower temperature than the hydrocarbon vapors and thereby condensing at least a portion of the hydrocarbon vapors.

The objects and advantages of the process will appear more fully from the following detailed description of the preferred version of the process, made in conjunction with the accompanying drawing.

### BRIEF DESCRIPTION OF THE DRAWINGS

The sole drawing FIGURE is a schematic of the process for continuous thermal decomposition of a plastic waste as disclosed herein.

### DETAILED DESCRIPTION

The terms “pyrolysis”, “decomposition”, “thermal decomposition’ or “thermal cracking” are used herein interchangeably for the thermochemical decomposition of waste plastic at elevated temperatures in the absence of oxygen to yield hydrocarbons.

The terms “hydrocarbon,” “hydrocarbon fuel,” and “hydrocarbon oil” are used herein interchangeably for describing the products obtained from the thermal decomposition reaction and comprise hydrocarbon chains of different length and structure which can be separated into light-range, middle distillate, and heavy oil. As the term is used herein, “hydrocarbon” includes linear, branched, and cyclic alkanes, alkenes, and alkynes, conjugated or unconjugated, of all description.

The principal aim of the method disclosed herein is to convert waste plastics to liquid hydrocarbon-containing fuels by thermal decomposition in a continuous system. The process and apparatus disclosed herein provide innovative techniques for recycling plastic waste and generating value-added products from it. The process and apparatus are designed to conduct accelerated and high-volume pyrolysis of plastic waste. The process and apparatus are also optimized to reduce overall energy consumption and atmospheric emissions.

The method can be used for thermal decomposition of all types of plastic wastes and mixtures. Some preferred target feedstocks include residential and commercial single-use plastic waste comprising polyethylene (PE) and/or polyphenylene ether (PPE). These are simply preferred waste streams. The method will work using waste streams comprising any poly(olefin) (for example, low-density polyethylene (LDPE), linear low-density polyethylene (LLDPE), very-low-density polyethylene (VLDPE), ultra-low-density polyethylene (ULDPE), medium-density polyethylene (MDPE), polypropylene (PP), polymethylpentene (PMP), polybutene-1 (PB-1); ethylene-octene copolymers, stereo-block PP, olefin block copolymers, propylene-butane copolymers, and the like; and polyolefin elastomers (POE), such as polyisobutylene (PIB), poly(α-olefin) s, ethylene propylene rubber (EPR), ethylene propylene diene monomer (M-class) rubber (EPDM rubber), etc. Polyester waste streams may also be used, including waste feedstocks comprising poly(bisphenol A isophthalate), poly(bisphenol A terephthalate), poly(butylene adipate), poly(butylene isophthalate), poly(butylene sebacate), poly(butylene succinate), poly(butylene terephthalate), poly(ethylene sebacate), poly(ethylene succinate), poly(caprolactone), poly(cyclohexylenedimethylene terephthalate), poly(ethylene adipate), poly(ethylene isophthalate), poly(ethylene naphthalate), poly(ethylene phthalate). poly(ethylene terephthalate), polyglycolide, poly(hexylene sebacate), poly(hexylene succinate), poly(3-hydroxybutyrate), poly(4-hydroxybutyrate), polylactic acid, poly(propylene adipate), poly(trimethylene succinate), poly(trimethylene terephthalate), and the like. The method may also be practiced using any halogenated version of the above, such as poly(vinyl chloride) and the like.

Referring to the drawing, an exemplary embodiment of the disclosure includes a stacked horizontal parallel configuration comprising an extruder 2 and a pyrolysis reactor 4 for thermal decomposition of plastic waste. The plastic waste is continuously fed into the extruder 2. In a preferred embodiment, the extruder 2 has an airlock or first seal 1 at the inlet, such as a rotary airlock. The extruder 2 is preferably operated at a temperature of from about 140 to about 350° C. (although temperatures above and below this range are possible). The temperature is monitored and controlled by monitors and moderators in place. The extruder 2 is configured to be an automatic feed-through system with internal rotation driven by a motor. In preferred embodiments, the extruder 2 is a twin screw extruder, which eliminates stagnant zones over the entire length of the process section and results in highly efficient and highly homogeneous mixing. The plastic waste is melted in the extruder 2 by at least 90%, at least 91%, at least 92%, at least 93%, at least 94%, at least 95%, at least 96%, at least 97%, at least 98%, or at least 99%. A small portion of the plastic waste, for example, about 1%, about 2%, about 3%, about 4%, or about 5%, is converted into hydrocarbon vapors and gases in the extruder 2.

In the exemplary embodiment shown in the FIGURE, the extruder 2 is positioned above the pyrolysis reactor 4. The melted plastics from the extruder 2 enter the pyrolysis reactor 4 by gravity through a connection pipe 3. The temperature of the melted plastic entering the pyrolysis reactor 4 is preferably at least about 320° C. The pyrolysis reactor 4 is preferably operated at a temperature of from about 370 to about 450° C. The temperature is monitored and controlled by monitors and moderators in place. Once inside the pyrolysis reactor 4, the melted plastics are quickly pyrolyzed in minutes to yield hydrocarbon-containing gases.

In preferred versions, the extruder 2 and the pyrolysis reactor 4 comprise horizontal tubes. The extruder 2 and the pyrolysis reactor 4 may be manufactured in any dimension and made of any materials that are suitable for continuous and long-term use under high temperature. For example, the pyrolysis reactor 4 may be made of 309, 316, or 330 stainless steel.

As the pyrolysis reactor 4 receives melted plastics from the extruder 2 continuously, carbon ashes formed in the pyrolysis reactor 4 are removed continuously through an outlet pipe 5 with an seal 6 into a conveyor 7. The carbon ashes are cooled down in the conveyor 7, and then discharged from the system through another seal 8. The seals 6 and 8 before and after the conveyor prevent leakage so that gases and heat within the conveyor 7 can be sent to the condensers or recycled.

All the vapors and gases yielded from the extruder 2, the pyrolysis reactor 4, and the conveyor 7 are sent to the condensers 9 and 10 through pipes 11-15 to produce liquid hydrocarbon fuel. The content of the product gases may comprise, among many other possible products, ethene, propene, pentane, benzene, and the like. Any condensing system known in the art may be used to condense the hydrocarbon vapors yielded from the process. In the exemplary embodiment shown in the FIGURE, the condensing system comprises two stages of condensers 9 and 10, which are double-wall tanks having rain showers inside. The rain shower uses produced hydrocarbon oils at a lower temperature (e.g., 100-220° C.) to mix with the hydrocarbon vapors and liquify the hydrocarbon vapors to generate more oils. The condensers 9 and 10 convert about 80%, about 81%, about 82%, about 83%, about 84%, about 85%, about 86%, about 87%, about 88%, about 89%, or about 90% of the hydrocarbon vapors and gases into condensed phase liquid hydrocarbons.

The process is optimized to reduce overall energy consumption by recycling waste heat and use it for heating the extruder 2 and the pyrolysis reactor 4. Any uncondensable gases are recycled to the burner 17 for heating the pyrolysis reactor 4. The extruder 2 is heated by a burner 16, which receives the flue gases from the burner 17 of the pyrolysis reactor 4 (pipe not shown), waste heat from the first stage condenser 9 through pipe 18, excess heat from the pyrolysis reactor 4 (pipe not shown) and waste heat from the conveyor 7 through pipe 19.

The pyrolysis reactor 4 is heated by a burner 17. To reduce carbon emission from the combustion, a carbon capture chamber 20 is installed at the outlet of the burner 17 to capture post-combustion CO₂ before the flue gases are released. Any post-combustion capture technique known in the art may be used. In a preferred embodiment, the carbon capture chamber contains basalt to capture CO₂. Basalt comprises calcium, iron, and magnesium, which react naturally with CO₂ to form solid carbonate minerals. The basalt catalyst may be prepared in any form, such as powders.

Before feeding to the extruder 2, the plastic waste may be grinded to an average particle size of roughly 0.25 mm to 1 mm and washed with water to remove any contaminants. Particle size can be evaluated by any method known in the art, such as sieving. The washed plastics are then run through centrifuge system to remove the majority of water, and then dried on a heated conveyor or belt, using flue gases from the burner 17.

The process and apparatus disclosed herein can be applied to convert various plastic waste to liquid hydrocarbon fuel by thermal decomposition. The process can reduce the volume of the plastic waste by at least 90%, at least 91%, at least 92%, at least 93%, at least 94%, at least 95%, at least 96%, or at least 97%.

In the foregoing description, certain terms have been used for brevity, clarity, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the foregoing description.

Any version of any component or method step of the invention may be used with any other component or method step of the invention. The elements described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further. these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1to 9, from 3.6 to 4.6, from 3.5 to 9.9, and so forth.

All patents, patent publications, and peer-reviewed publications (i.e., “references”) cited herein are expressly incorporated by reference in their entirety to the same extent as if each individual reference were specifically and individually indicated as being incorporated by reference. In case of conflict between the present disclosure and the incorporated references, the present disclosure controls.

The systems and methods disclosed herein can comprise, consist of, or consist essentially of the essential elements and limitations described herein, as well as any additional or optional steps, components, or limitations described herein or otherwise useful in the art.

While this method disclosed herein may be embodied in many forms, what is described in detail herein is a specific preferred embodiment of the method and apparatus. The present disclosure is an exemplification of the principles of the method is not intended to limit the method to the particular embodiments illustrated. It is to be understood that this method is not limited to the particular examples, process steps, and materials disclosed herein as such process steps and materials may vary somewhat. It is also understood that the terminology used herein is used for the purpose of describing particular embodiments only and is not intended to be limiting since the scope of the claimed invention will be defined by the appended claims and equivalents thereof.

What is claimed is:

1. A process for continuous thermal decomposition of a plastic waste, the process comprising:
(a) feeding the plastic waste continuously into an extruder, wherein the plastic waste is melted at a temperature of about 100° C. to about 350° C.;
(b) feeding the melted plastic waste from the extruder continuously into a pyrolysis reactor operating at a temperature of about 280° C. to about 900° C.;
(c) condensing at least a portion of hydrocarbon vapors formed in the extruder and the pyrolysis reactor in a condenser to yield liquid hydrocarbon fuel; and
(d) discharging carbon ashes formed in the pyrolysis reactor continuously.

2. The process of claim 1, wherein in step (a) the plastic waste is melted at a temperature of about 140° C. to about 350° C.

3. The process of claim 1, wherein in step (b) the melted plastic waste from the extruder is fed into the pyrolysis reactor operating at a temperature of about 370° C. to about 450° C.

4. The process of claim 1, wherein the extruder has a seal at the inlet.

5. The process of claim 1, wherein the extruder is configured to rotate internally.

6. The process of claim 1, wherein the extruder is positioned above the pyrolysis reactor, and the melted plastic waste from the extruder enters the pyrolysis reactor by gravity.

7. The process of claim 1, wherein in step (d) the carbon ashes are removed from the pyrolysis reactor through a first seal to a conveyor to cool down, and then discharged through a second seal.

8. The process of claim 1, wherein the pyrolysis reactor is heated by a burner.

9. The process of claim 8, wherein the burner is connected to a carbon capture chamber to reduce carbon emissions.

10. The process of claim 9, wherein the carbon capture chamber contains basalt to absorb CO₂ from the burner.

11. The process of claim 1, wherein in step (c) the condenser uses a rain shower to mix hydrocarbon fuel at a lower temperature with the hydrocarbon vapors to yield additional liquid hydrocarbon fuel.

12. The process of claim 1, further comprising prior to step (a) grinding the plastic waste before feeding it to the extruder.

13. The process of claim 12, wherein the plastic waste is ground to an average particle size of about 0.25 mm to about 1 mm.

14. A device dimensioned and configured for continuous thermal decomposition of a plastic waste, the device comprising:
an extruder having an inlet and an outlet and configured to melt and extrude plastic waste at a temperature of about 100° C. to about 350° C.; wherein the outlet of the extruder is operationally connected to;
a pyrolysis reactor having an inlet and outlet and configured to operate at a temperature of about 280° C. to about 900° C., such that plastic extruded from the outlet of the extruder enters the pyrolysis reacted via the pyrolysis reactor inlet; and
a condenser operationally connected to the extruder and the pyrolysis reactor and dimensioned and configured to condense at least a portion of hydrocarbon vapors formed in the extruder and the pyrolysis reactor to yield liquid hydrocarbon fuel.

15. The device of claim 14, further comprising a burner disposed, dimensioned, and configured to heat the pyrolysis reactor to temperatures ranging from about 280° C. to about 900° C.

16. The device of claim 15, wherein the burner is connected to a carbon capture chamber dimensioned and configured to reduce carbon emissions from the burner.

17. The device of claim 16, wherein the carbon capture chamber contains basalt to absorb CO₂ generated by the burner.

18. The device of claim 14, wherein in step (c) the condenser comprises a rain shower that contacts liquid hydrocarbon fuel with at least a portion of hydrocarbon vapors in the pyrolysis chamber, wherein the liquid hydrocarbon fuel is at a lower temperature than the hydrocarbon vapors and thereby condensing at least a portion of the hydrocarbon vapors.
